(19) United States
(12) Patent Application Publication
(10) Pub. No.: US 2020/0101518 A1
(43) Pub. Date: Apr. 2, 2020

(54) KIT AND METHOD FOR JUNCTION OF PIPES

(71) Applicant: EUROTUBI EUROPA S.R.L., Milano (IT)

(72) Inventor: Luigi MALGRATI, Gorgonzola (Milano) (IT)

(21) Appl. No.: 16/492,072

(22) PCT Filed: Mar. 8, 2017
(86) PCT No.: PCT/IT2017/000047

§ 371 Date: Sep. 6, 2019

(51) Int. Cl. B21D 39/04; F16L 13/14; F16L 13/16

(52) U.S. Cl. CPC B21D 39/046; F16L 13/161; F16L 13/142

(57) ABSTRACT

A kit and a related method for connecting pipes, comprising: including: a tubular fitting having at least one access end for an end portion of a respective pipe to be connected; said access end of the fitting having at least one fluid-sealing gasket interposed between an inner surface of the fitting and an outer surface of the pipe; and a pressing tool configured to implement a radial plastic deformation action on the access end defining a stable coupling condition between said fitting and the respective pipe; the pressing tool comprising including at least one tooth extending radially with respect to the circumferential extension of the fitting and the pipe; said access end of the fitting comprising including at least one radial projection formed as a result of the plastic deformation action, said projection being at least partially inserted in the outer surface of said pipe.

### TECHNICAL FIELD

The present invention relates to a kit and a related method for connecting pipes. In greater detail, the present invention finds particular application in connecting thick-walled pipes to each other by means of press fittings.

The pipes that are connected can be of any type. However, the Applicant has found important advantages in the use of the kit and the related method in accordance with the present invention, according to the United States standards, for the connection of pipes of the “black iron pipe” type ASTM A53, A106, A135 and A795 schedule 5-schedule 40, optionally surface treated and then coated with protective products and, according to European standards, for the connection of black steel pipes, which are galvanized or painted or in general also superficially coated, referring to the following regulations: UNI EN 10255, UNI EN 10220/10216-1, UNI EN 10220/10217-1.

### STATE OF THE ART

As is known, connections made by pressing, commonly referred to as “press fittings” are used to permanently connect the pipes to each other.

In particular, these connections are formed by a tubular fitting, which may have different configurations depending on the particular geometry that shall define the connection. For example, the fitting may be linear for the coupling of pipes arranged along the same longitudinal axis or may be curved or T-shaped to position the pipes with the respective longitudinal extensions transverse to each other.

Each end of the fitting is fitted into that of the respective pipe to be connected and is radially closed on itself with a suitable tool capable of plastically and permanently deforming the ends.

The fitting also has, at an inner surface thereof, an annular gasket or “O-ring” that, when the end of the fitting is deformed at the end of the pipe, adheres to the outer surface of the pipe to prevent the leakage of fluid (liquid or gas) flowing in the pipes.

The tool for the plastic deformation of the fitting on the pipe is typically constituted by a pair of jaws which can be positioned on the opposite side of the end of the fitting to close an annular portion of the same fitting on the pipe.

The jaws are operable manually by the operator so as to act with a predetermined shape adapted to sufficiently deform the fitting and the pipe, defining its mechanical and hydraulic seal.

For this purpose, the jaws have an annular surface in contact with the fitting, which is suitably shaped complementarily to the shape of the fitting itself so as to act on the fitting end which incorporates a containment chamber of the annular gasket.

However, the press fitting connecting systems have serious limitations of use, in particular for the coupling of thick-walled pipes.

In fact, in order to establish an optimum plastic deformation between the fitting and the pipe, it is necessary to use fittings and pipes with reduced thickness which are easily jointly deformable by means of the tool.

In this context, the use of thick-walled pipes makes it difficult, if not impossible, to use this joining technique.

In order to overcome this drawback, fittings are used which are also capable of mechanically connecting pipes with increased thickness.

An example of this type of fittings is illustrated in document WO 201089188 A1 relating to a fitting internally provided with a semicircular (C-shaped) body adapted to engage the outer surface of the pipe.

In particular, a fitting is described which is internally provided with an annular chamber for containing the semicircular body, which chamber is arranged adjacent to the containment chamber of the gasket.

The semicircular body is provided with a series of teeth projecting radially towards the interior (towards the pipe) of the fitting.

In this way, following the compression action of the jaws, only the fitting is deformed and the semicircular body is tightened around the pipe, so that the teeth partially penetrate into the outer surface of the pipe.

In this way, the semicircular body which is engaged inside the fitting defines a mechanical constraint with the pipe, thereby avoiding to deform, if not only superficially, the pipe itself.

Although this solution also allows for the coupling of considerably thick, and therefore non-deformable, pipes, however, it has some major drawbacks.

Firstly, the Applicant has observed that fittings internally provided with the aforementioned semicircular toothed body are structurally very complex precisely because of the presence of this body.

In fact, it should be noted that the semicircular toothed body, once manufactured, must be inserted inside the fitting which is shaped specifically to accommodate the respective semicircular body.

This implies a very complex structure of the fitting, which in the production phase must be suitably shaped to provide the annular seat for housing the semicircular body.

Moreover, in the production phase, the fitting must undergo one or more additional steps of positioning the semicircular body in the respective annular seat.

In this connection, it should be considered that the fitting may have two or more ends for housing the pipes and therefore the action of positioning the semicircular body is repeated a number of times equal to the number of ends of the fitting.

Consequently, this type of fittings appears to be structurally very complex and with high production costs.

Another important drawback of the prior art is the size of the tool which must exert a very high compression force in order to deform the fitting and at the same time tighten the semicircular body to make the teeth penetrate into the surface of the pipe.

This drawback, too, has considerable disadvantages in terms of practicality of use, structural simplicity of the jaws and manufacturing costs.

### OBJECT OF THE INVENTION

The object of the present invention is therefore to provide a kit and a method for connecting pipes, which can solve the above-mentioned drawbacks of the prior art.

In particular, one object of the present invention is to provide a connection kit that can be used for thick-walled pipes and is structurally simple and with particularly low costs.

A further object of the present invention is to provide a kit for connecting pipes which is versatile and for use with different types of fittings without having to modify the structure of the fittings normally used within the scope of the press fitting connections.

Yet another object of the present invention is to provide a method of connecting pipes, in particular thick-walled pipes, which is simple and particularly fast.

These and still other objects are achieved by means of a kit and a related method for connecting pipes in accordance with the present invention.

In particular, according to a first aspect the present invention relates to a kit for connecting pipes comprising a tubular fitting having at least one access end for an end portion of a respective pipe to be connected. The access end of the fitting has at least one fluid-sealing gasket interposed between an inner surface of the fitting and an outer surface of the pipe. The kit also comprises a pressing tool configured to implement a radial plastic deformation action on the access end defining a stable coupling condition between said fitting and the respective pipe. The pressing tool comprises at least one tooth extending radially with respect to the circumferential extension of the fitting and pipe to create, in the access end of the fitting, at least one radial projection formed as a result of the plastic deformation action. The projection is at least partially inserted in the outer surface of the pipe for mechanically linking the fitting to the pipe. In accordance with a further aspect the invention also relates to a method for connecting pipes, comprising the steps of inserting at least one end portion of a respective pipe inside an access end of a tubular fitting and implementing a radial plastic deformation action on the access end of the fitting to define a stable coupling condition between said fitting and the respective pipe. The step of implementing the plastic deformation is characterised by providing at least one projection extending radially from an inner surface of the access end of the fitting, and inserting, at least partially, the projection in the outer surface of the pipe.

The plastic deformation action is carried out only on the access end of the fitting without deforming the pipe.

Further features and advantages will become more apparent from the detailed description of preferred, but not exclusive embodiments of a kit and a related method for connecting pipes according to the present invention.

### BRIEF DESCRIPTION OF THE DRAWINGS

This description will be set forth hereinafter with reference to the accompanying drawings, provided to a merely indicative and therefore non-limiting purpose, in which:

FIG. 1 is a perspective view of a kit for connecting pipes according to the present invention and in a respective condition of use;

FIGS. 2a and 2b are partially sectional side views of the kit for connecting pipes in accordance with a first embodiment and in respective operating phases;

FIGS. 2b and 2c are views of the kit of FIG. 2b in accordance with respective alternative embodiments of the connection;

FIGS. 3a and 3b are partially sectional side views of the kit for connecting pipes in accordance with a second embodiment and in respective operating phases; and

FIGS. 4a and 4b are schematic plan views of a pressing tool forming part of the kit according to the present invention and in accordance with a first and a second embodiment.

### DETAILED DESCRIPTION OF PREFERRED EMBODIMENTS OF THE INVENTION

With reference to the accompanying figures, the numeral 1 indicates, as a whole, a kit for connecting pipes according to the present invention.

In particular, the present invention finds use in pipes 2 of various kinds which are used for the construction of plants for the passage of fluids such as water or gas.

However, as specified above, the Applicant has found important advantages in the use of the kit 1 and the related method in accordance with the present invention, according to the United States standards, for the connection of pipes of the “black iron pipe” type ASTM A53, A106, A135 and A795 schedule 5-schedule 40, and according to European standards, for the connection of black, galvanized or painted, steel pipes, referring to the following regulations: UNI EN 10255, UNI EN 10220/10216-1, UNI EN 10220/10217-1.

These pipes may have nominal diameters ranging from 10 to 50 mm, and a nominal outside diameter of from 17.2 to 60.3 mm.

Moreover, these pipes have a large thickness preferably comprised between 1.8 to 16 mm.

In addition, the pipes may have a surface finish designed to give greater protection to the pipes themselves. The surface coatings can be of any known type.

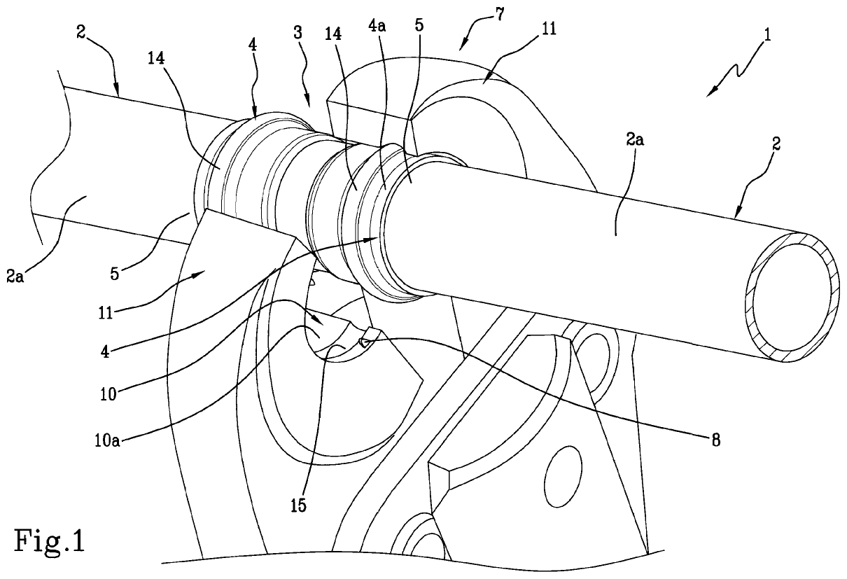

As is better illustrated in FIG. 1, the kit 1 comprises a tubular fitting 3 having at least one access end 4 for an end portion 5 of a respective pipe 2 to be connected.

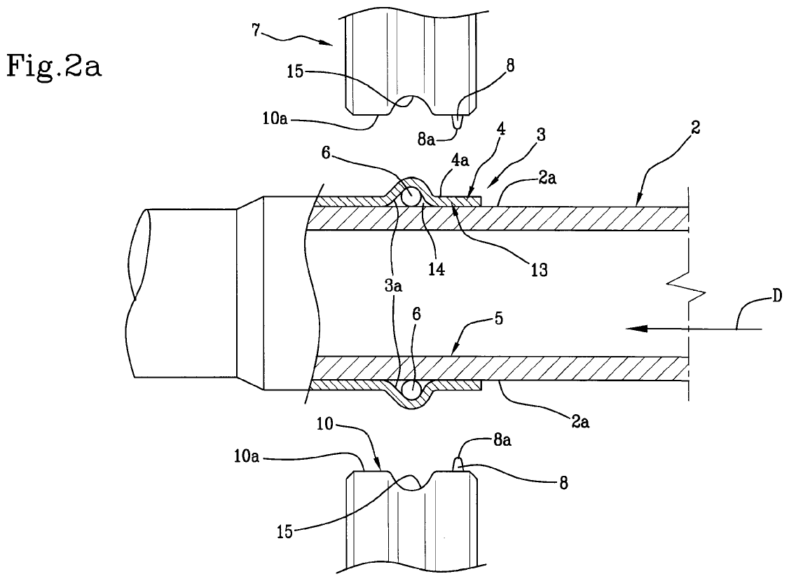

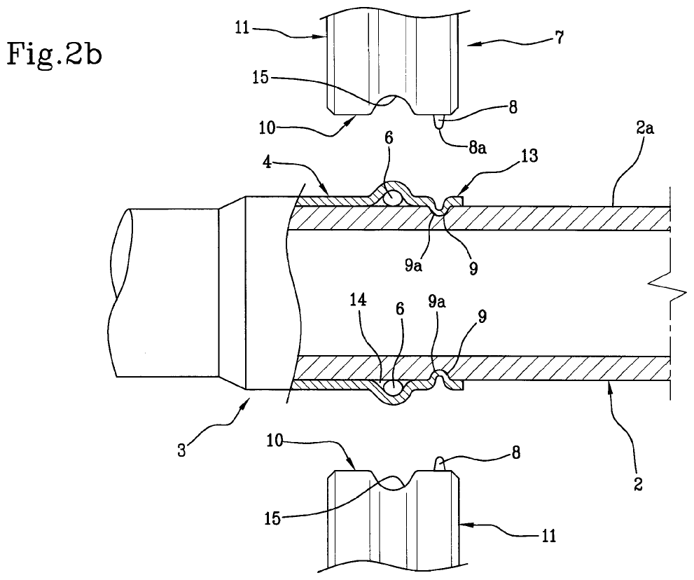

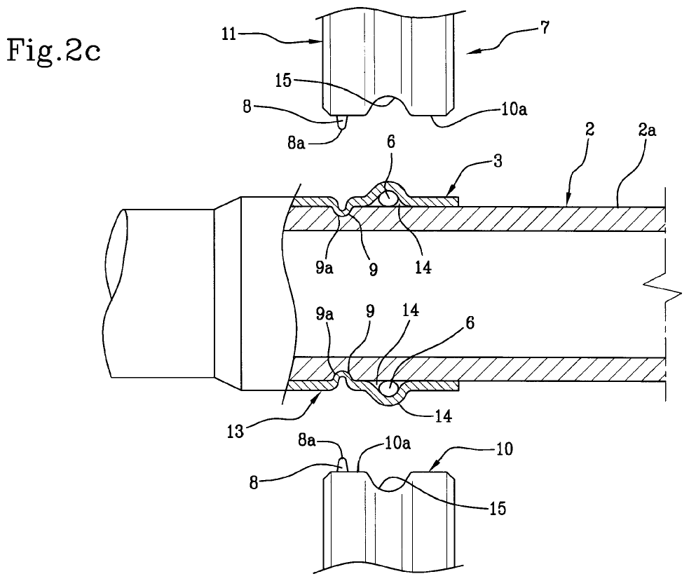

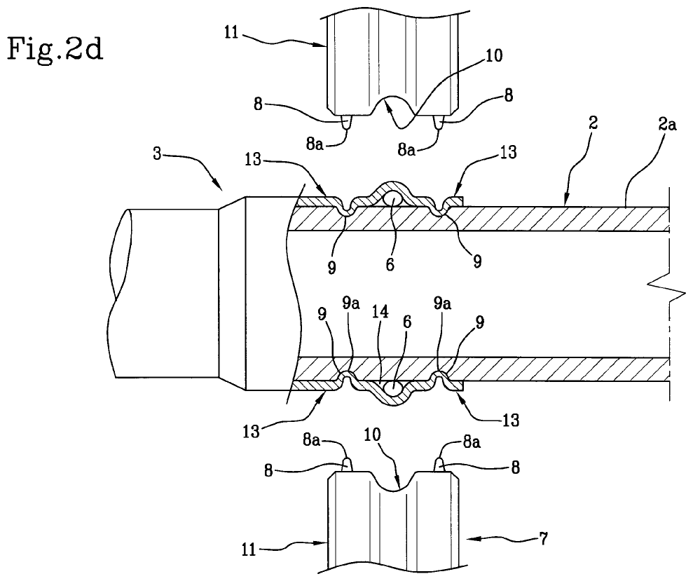

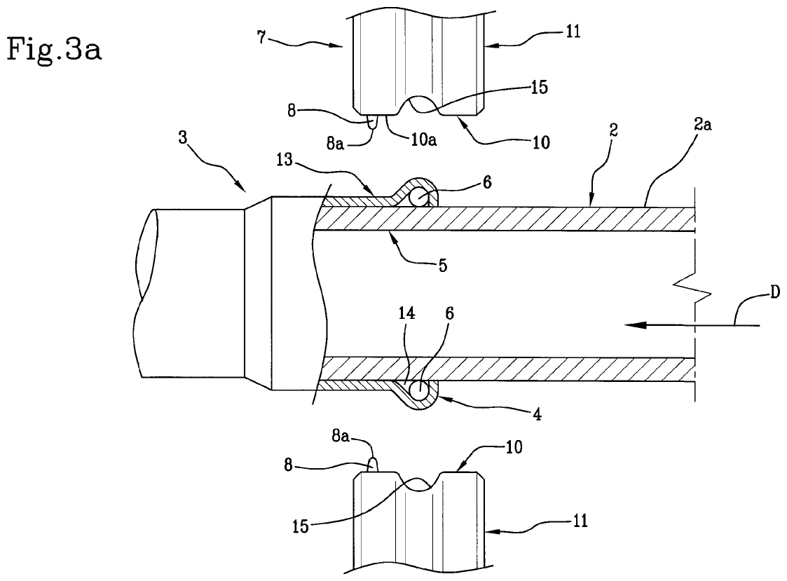

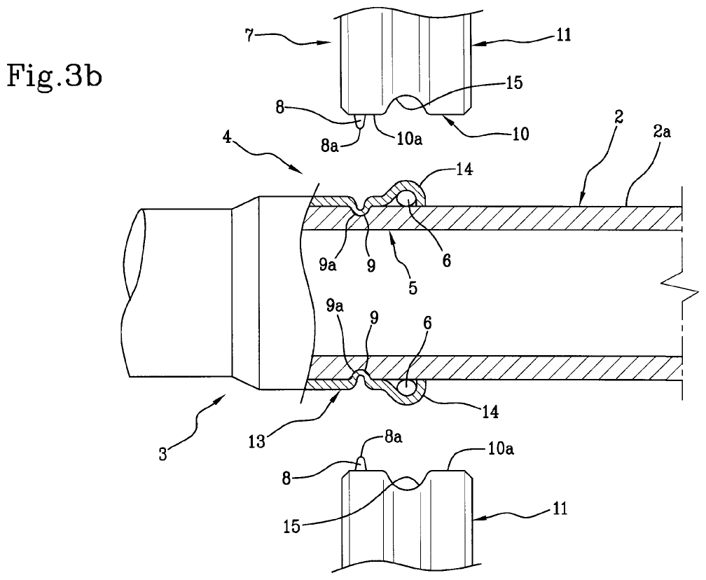

The fitting 3, which displays a circular profile in cross-section, may be of the V-shaped profile type as shown in FIGS. 1, 2a, and 2b, or of the M-shaped profile type as shown in FIGS. 3a and 3b.

Preferably, the fitting 3 is made of carbon material and has a thickness of about 1.5 mm.

Furthermore, the fitting 3 may extend rectilinearly and therefore along the same longitudinal axis, or may define a coupling angle or curve between two pipes 2 transverse to each other.

Moreover, the fitting 3 may have a single access end 4 for connecting a pipe 2 or, as shown in FIG. 1, may have two opposite access ends 4. In some embodiments, the fitting 3 may have a T-shaped profile for the connection of three pipes 2. In this case, for each pipe there is one access end 4 of the respective pipe 2.

Each access end 4 of the fitting 3 has at least one fluid-sealing gasket 6 interposed between an inner surface 3a of the fitting 3 and an outer surface 2a of the pipe 2.

The kit 1 also comprises a pressing tool 7 configured to implement a radial plastic deformation action on the access end 4.

This compression action (FIGS. 2b and 3b) defines a stable coupling condition between the fitting 3 and the respective pipe 2 in which there is both a fluid and a mechanical seal.

As will be better clarified in the following of this specification, the pressing tool 7 comprises at least one tooth 8 extending radially with respect to the circumferential extension of the fitting 3 and the pipe 2.

The tooth 8 defines a radial projection 9 extending from the access end 4 of the fitting 3 which is formed as a result of the plastic deformation action. As is better illustrated in FIGS. 2b and 3b, the projection 9 is at least partially inserted in the outer surface 2a of the pipe 2.

In greater detail, the pressing tool 7 comprises an annular surface 10 configured to be positioned around the outer surface 4a of the access end 4 and compress the same by radially pressing the end 4 itself around the outer surface 2a of the pipe 2.

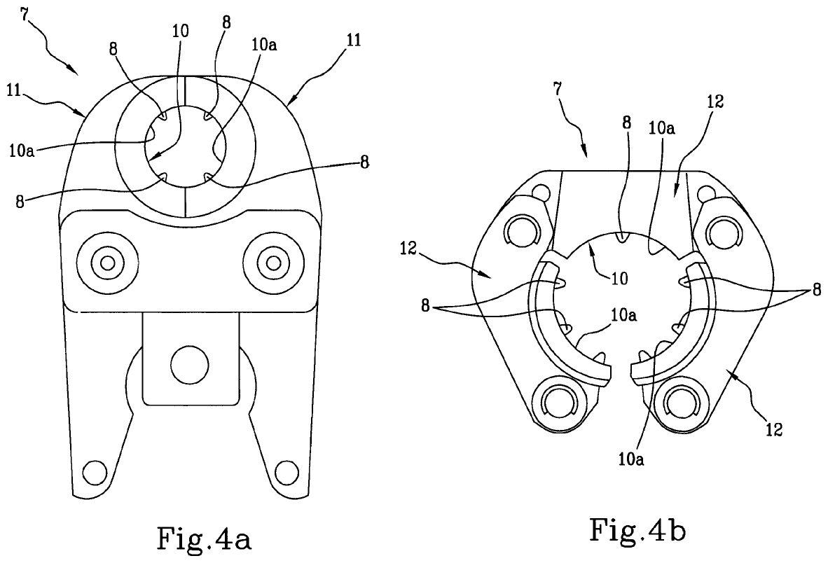

In accordance with a first possible embodiment exemplarily illustrated in FIGS. 1 and 4a, the tool 7 has a clamp-like configuration, in which two jaws 11 hinged to each other and movable towards/away from each other are set to define the pressing action on the fitting 3.

Each jaw 11 has a respective portion 10a (half) that defines the entire annular surface 10.

In accordance with a second embodiment illustrated in FIG. 4b, the tool 7 has a chain-like configuration, and has a plurality of segments 12 (preferably three segments 12) hinged to each other, each of which defining a respective portion 10a of said annular surface 10.

In this case, too, the segments 12 are hinged to each other and are movable towards/away from each other to define the pressing action on the fitting 3.

Advantageously, the tool 7 in the two possible embodiments has an actuator, not shown because of known type, which can be operated manually and is adapted to apply a predetermined pressure force on the fitting 3.

As is illustrated in the accompanying figures, the tooth 8 extends radially from said annular surface 10.

Advantageously, a plurality of teeth 8 are provided, which extend radially from the annular surface 10 and are suitably spaced so as to be arranged according to a circumferential path defined by the surface 10.

The number and positioning of the teeth 8 may be of any type depending on the various operating requirements and on the basis of the type of pipes to be connected.

In this situation, a projection 9 is formed for each tooth 8.

In greater detail, each tooth 8 substantially has the shape of a “wedge” defining an end 8a, which is distal to the annular surface 10, is tapered and has a decreasing section.

Consequently, each projection 9 substantially has the shape of a “wedge” shaped complementarily to the respective tooth 8.

The projection 9 has an end 9a, which is distal to the inner surface 3a of the fitting 3, is tapered and has a decreasing section. This end 9a has the function of scratching the surface of the pipe 2 to interfere with it.

Consequently, each end 9a appears to be inserted in the outer surface 2a of the pipe 2 in order to define a mechanical constraint between the pipe 2 and the fitting 3.

It should also be noted that the projections 9 extend radially from the inner surface 3a of the fitting 3 and along an annular area 13 of the above-mentioned access end 4.

In accordance with a first embodiment shown in FIGS. 2a and 2b, wherein the fitting 3 is of the V-shaped profile type, the annular area 13 is arranged upstream of the gasket 6 with respect to the direction “D” of insertion of the pipe 2 in the access end 4.

In other words, in this situation the projections 9 are formed in an annular flap of the fitting 3 which defines the insertion mouth of the pipe 2.

Alternatively, as shown in FIG. 2c in which a fitting 3 with a V-shaped profile is again illustrated, the annular area 13 can be defined downstream of the gasket 6 with respect to the direction “D”. In this case, the teeth 8 are suitably positioned to define the projections 9 in a region distal to the insertion mouth of the pipe 2.

Still in accordance with a further embodiment shown in FIG. 2d, the annular area 13 may be defined by opposite sides of the gasket 6. In this solution, the projections 9 are therefore formed on both sides of the gasket, thus defining an even more stable mechanical constraint (resistant to very high fluid pressures) between the pipe 2 and the fitting 3. The teeth 8 are therefore projecting from appropriate areas of the surface 10.

In accordance with a further embodiment shown in FIGS. 3a and 3b, wherein the fitting 3 is of the M-shaped profile type, the annular area 13 is arranged downstream of the gasket 6 with respect to the direction “D” of insertion of the pipe 2 in the access end 4.

In this situation, the projections 9 are formed towards an innermost area of the fitting 3, whereas the gasket 6 is closer to the insertion mouth of the pipe 2.

Preferably, the fluid-sealing gasket 6 is housed in an annular chamber 14 formed in said access end 4 and projecting with respect to the upper surface 4a of the end 4 itself.

The annular surface 10 of the tool 7 has a circumferential lead 15 adapted to abut against the annular chamber 14 in order to allow for the deformation of the chamber 14, which causes the compression of the gasket 6 on the outer surface 2a of the pipe 2.

The present invention further relates to a method for connecting pipes 2 by using the kit 1 described above mainly as regards structure.

The method comprises the steps of inserting at least one end portion 5 of a respective pipe 2 inside the access end 4 of a tubular fitting 4 and along the said insertion direction “D”.

Subsequently, the radial plastic deformation action is carried out on the access end 4 of the fitting 3 to define a stable coupling condition between the fitting 3 and the respective pipe 2.

In turn, the step of implementing the plastic deformation is carried out by providing at least one projection 9 extending radially from an inner surface 3a of the fitting 3, and inserting, at least partially, the projection 9 in the outer surface 2a of the pipe 2.

Preferably, the plastic deformation action is carried out by simultaneously forming a plurality of projections 9 extending radially from the access end 4 of the fitting 3, each of which interfering with the outer surface 2a of the pipe 2.

It should be noted that, as shown in FIGS. 2b and 3b, the plastic deformation action is implemented only on the access end 4 of the fitting 3 without thus deforming the pipe 2.

In other words, the sole deformation action bends the fitting 3, thus leaving the pipe section 2 unchanged (not compressed). The sole interference action of the projections 9 only scratches the surface of the pipe 2 in order to implement the mechanical coupling.

However, in the case of pipes with reduced thickness, it is also possible to deform the pipe, thus ensuring a greater mechanical seal.

As specified above, the radial plastic deformation action is carried out by the pressing tool 7 of the type described above and illustrated in FIGS. 4a and 4b, which is configured to press the fitting 4 on the pipe 2.

The creation of each projection 9 is performed by at least one respective tooth 8 adapted to bend a portion of the fitting 3 so that at least the end 9a of the projection 9 interferes with the outer surface 2a of the pipe 2.

Simultaneously with the creation of the projection 9, the gasket 6 arranged in the access end 4 of the fitting 3 is also radially pressed to define the aforementioned fluid seal between the fitting 3 and the pipe 2.

Therefore, the present invention solves the problems encountered in the prior art and entails major advantages.

Firstly, the connection kit 1 can be used for thick-walled pipes 2 since it acts by deforming not the pipe 2 itself but only the fitting 3 which, in turn, can be manufactured with a reduced thickness.

As a result, the kit 1 proves to be structurally simple and with particularly low costs since the fittings 3 are not modified in their structure with respect to those normally used in the context of the press fitting connections used for pipes of different sizes.

In other words, the fitting 3 is usable both for the press fitting solution, in which also limited thickness pipes are bent, and for the connection of thick-walled pipes 2.

It should be noted that for reduced thickness pipes, the deformation is simultaneously carried out on the fitting and the pipe itself, thus ensuring a better mechanical seal of the connections.

Advantageously, the fitting 3 (both with the V-shaped profile and the M-shaped profile) is thus very versatile for any pipe to be connected.

Moreover, the formation of the projections 9 for the coupling to the pipe 2 is particularly simple since it is achieved by the action of the tool 7 with a predetermined pressure value.

This entails a method that is very simple, fast and therefore with particularly low costs, which allows for connecting pipes of various kinds, even thick-walled pipes.

Even the size of the tool 7 can be reduced, as it does not need to bend the pipe 2 but only the fitting 3, which as described above has a reduced thickness.

1. A kit for connecting pipes, comprising:
a tubular fitting having at least one access end for an end portion of a respective pipe to be connected;
said access end of the fitting having at least one fluid-sealing gasket interposed between an inner surface of the fitting and an outer surface of the pipe; and
a pressing tool configured to implement a radial plastic deformation action on the access end defining a stable coupling condition between said fitting and the respective pipe;
wherein said pressing tool comprises at least one tooth extending radially with respect to the circumferential extension of the fitting and the pipe; and that said access end of the fitting comprises at least one radial projection formed as a result of the plastic deformation action, said projection being at least partially inserted in the outer surface of said pipe.

2. The kit according to claim 1, wherein said pressing tool comprises an annular surface configured to be positioned around the outer surface of the access end to implement said radial deformation action; said tooth extending from said annular surface.

3. The kit according to claim 1, wherein said pressing tool comprises at least two jaws, each of which defining a respective portion of said annular surface.

4. The kit according to claim 2, wherein said pressing tool comprises a plurality of segments hinged to each other, each of which defining a respective portion of said annular surface.

5. The kit according to claim 2, wherein said tooth substantially has the shape of a “wedge” defining an end, which is distal to the annular surface, is tapered and has a decreasing section.

6. The kit according to claim 2, wherein said tool comprises a plurality of teeth extending radially from said annular surface.

7. The kit according to claim 1, wherein said radial projection substantially has the shape of a “wedge” defining an end, which is distal to the inner surface of the fitting, is tapered and has a decreasing section; said end being inserted in the outer surface of the pipe for mechanically linking the pipe itself.

8. The kit according to claim 7, wherein it comprises a plurality of projections extending radially from the inner surface of the fitting and arranged along an annular area of said access end.

9. The kit according to claim 8, wherein said annular area is arranged upstream of the gasket with respect to the direction of insertion of the pipe in the access end.

10. The kit according to claim 8, wherein said annular area is arranged downstream of the gasket with respect to the direction of insertion of the pipe in the access end.

11. The kit according to claim 7, wherein it comprises a plurality of projections extending radially from the inner surface of the fitting and arranged along two annular areas of said access end, which are arranged on opposite sides of the gasket.

12. The kit according to claim 2, wherein said fluid-sealing gasket is housed in an annular chamber formed in said access end; said annular surface of the pressing tool having a circumferential lead adapted to abut against the annular chamber in order to deform said chamber and the gasket contained therein on the outer surface of the pipe.

13. A method for connecting pipes, comprising the steps of:
inserting at least one end portion of a respective pipe inside one access end of a tubular fitting;
carrying out a radial plastic deformation action on the access end of the fitting to define a stable coupling condition between said fitting and the respective pipe;
wherein said step of carrying out the plastic deformation comprises the substeps of:
forming at least one projection extending radially from an inner surface of the access end of the fitting; and
inserting, at least partially, the projection in the outer surface of said pipe.

14. The method according to claim 13, wherein said plastic deformation action is implemented only on the access end of the fitting; said pipe not being deformed.

15. The method according to claim 13, wherein said step of carrying out the plastic deformation comprises the substep of simultaneously forming a plurality of projections extending radially from the access end of the fitting, each of which interfering with the outer surface of the pipe.

16. The method according to claim 13, wherein said radial plastic deformation action is carried out by a pressing tool configured to press the fitting on the pipe.

17. The method according to claim 16, wherein said substep of forming at least one projection is performed by at least one tooth arranged in said tool for bending a portion of the fitting so that at least one portion of the projection interferes with the outer surface of the pipe.

18. The method according to claim 13, wherein said step of carrying out the plastic deformation further comprises the substep of radially pressing a gasket arranged in the access end of the fitting to define a fluid seal between the fitting and the pipe.
